(19) United States
(12) Patent Application Publication
(10) Pub. No.: US 2013/0021350 A1
(43) Pub. Date: Jan. 24, 2013

(54) APPARATUS AND METHOD FOR DECODING USING COEFFICIENT COMPRESSION

(71) Applicants: Michael L. Schmit, Cupertino, CA (US); Vicky W. Tsang, Belmont, CA (US); Radhakrishna Giduthuri, Campbell, CA (US)

(72) Inventors: Michael L. Schmit, Cupertino, CA (US); Vicky W. Tsang, Belmont, CA (US); Radhakrishna Giduthuri, Campbell, CA (US)

(73) Assignee: ADVANCED MICRO DEVICES, INC., Sunnyvale, CA (US)

(21) Appl. No.: 13/186,007

(22) Filed: Jul. 19, 2011

(51) Int. Cl. G06T 1/20

(52) U.S. Cl. 345/506

(57) ABSTRACT

Methods and apparatus for utilizing coefficient compression in graphics decoding are provided. In one example, a computer processing unit (CPU) is interfaced with a graphic processing unit (GPU) where the CPU extracts coefficients and passes compressed coefficient data, preferably in uniformly sized data packets, to the GPU for decoding and coefficient processing. Preferably the extracted coefficients are inverse transform (iT) coefficients and CPU includes an encoder control component configured to adaptively select a coefficient encoding process for performing the iT coefficient data compression based on the data content of the iT coefficients such that data packets are generated that include data that indentifies the selected coefficient encoding process used for encoding the compressed iT coefficient data contained in the data packet. In such case, the GPU is configured to receive such data packets and decode the iT coefficient data within each packet using a coefficient decoding method complementary to the selected coefficient encoding process identified within the packet. The GPU preferably uses massively parallel coefficient decoding of such data packets.

### FIELD OF INVENTION

The present invention is generally directed to decoding graphics/video and, in particular, to integrated circuits that share the decoding of graphics, such as central processing units (CPUs) and graphics processing units (GPUs), and related methods.

### BACKGROUND

Graphics processing units (GPUs) have been developed to assist in the expedient display of computer generated images and video. Typically a two-dimensional (2D) and/or three-dimensional (3D) engine associated with a computer's central processing unit (CPU) will render images and video as data that is stored in frame buffers of system memory. A GPU will assist the CPU to process the data in a selected manner to provide a desired type of video signal output.

Various CPU/GPU work sharing systems have been developed for decoding encoded video and generating a signals suitable for driving display device, such as DAC (Digital to Analog Converter), DVI (Digital Visual Interface) or HDMI (High-Definition Multimedia Interface) signals. Starting when computing devices were first used to decode DVD-Video, there has been a partitioning of graphic processing functions where a CPU decodes some portion of a video stream, such as an MPEG-2 stream, and a GPU does the remainder of the processing to provide a formatted output suitable for a display device. Initially, GPUs would primarily function to process a color space conversion (YUV to RGB) and scaling from the native decoded size to fit in a desired window or full screen for a display. Thereafter, GPUs began to process motion compensation (MC) functions, since these functions are memory bandwidth intensive. An early example of a GPU with expanded capabilities was the RagePro GPU developed in 1997 and sold by ATI Technologies, Inc.

One common method for encoding graphics/video involves encoding using discrete-cosine transform (DCT) processing so the encoded video content is translated into DCT coefficients. To playback/decode such encoded video, the use of inverse discrete-cosine transform (iDCT) processing is one of the required steps.

For MPEG-2 encoding of video, the video is first defined in pixels represent by YUV values and then DCT processing is performed with respect to blocks of YUV pixel data to result in blocks of DCT coefficients that are quantized and then entropy coded using a variable-length code (VLC) that results in much of the video data of an MPEG-2 encoded bit stream that generally also includes motion vector and audio data as well. To decode the video of such an MPEG-2 bit stream, the processes with respect to the VLC encoded data must be reversed, but some loss of data quality is sacrificed because the encoding quantization process is not fully reversible.

Typically, in addition to processing other components of an MPEG-2 bit stream, a computer's CPU will perform variable-length code decoding (VLD) and inverse quantization to derive inverse discrete-cosine transform (iDCT) coefficients that closely correspond to the original DCT coefficients which then must be iDCT processed. To further reduce the CPU's processing load in decoding video, there has been a shift of the performance of iDCT calculations to the GPU. In 1998-1999 Microsoft standardized the CPU-GPU interface due to the high desirability of providing high quality MPEG-2 decoding for DVD playback on Windows PCs with an interface known as DXVA (DirectX Video Acceleration). This interface is a part of a general graphics chip application programming interface (API) called DirectX. Information regarding the DXVA interface is available on Microsoft's website at: http://msdn.microsoft.com/en-us/library/ff568238(v=vs.85).aspx where it is stated that:
The DirectX VA interface supports various ways of handling low-level inverse discrete-cosine transform (iDCT). There are two fundamental types of operation:
   1. Off-host iDCT: Passing macroblocks of transform coefficients to the accelerator for external iDCT, picture reconstruction, and reconstruction clipping.
   2. Host-based iDCT: Performing an iDCT on the host and passing blocks of spatial-domain results to the accelerator for external picture reconstruction and reconstruction clipping.
In both cases, the basic inverse-quantization process, pre-iDCT range saturation, MPEG-2 mismatch control (if necessary), and intra-DC offset (if necessary) are performed on the host. In both cases, the final picture reconstruction and reconstruction clipping are done on the accelerator.

FIG. 1 provides an illustration of a CPU coupled to a GPU via a standard DXVA interface where the GPU performs the iDCT processing. As illustrated in FIG. 1, the CPU processes the MPEG-2 encoded video to extract the iDCT coefficients and passes macroblocks of iDCT coefficients to the GPU for iDCT processing via an iDCT coefficient data interface 100 such as a data bus coupling on a personal computer motherboard. The CPU also passes a motion vector list and various other data items related to display order logic and associated audio. However, the iDCT coefficients constitute the overwhelming portion of the data passed to the GPU for video processing, since the iDCT coefficients contain the information to define the display characteristics of each pixel of each frame of video.

The DXVA (and DXVA-like) interfaces are designed around the concept of using the decode processing for real-time playback of video where the CPU offloads a portion of the work to the GPU. The DXVA interface has worked well for relatively low resolution video processed for display at a typical thirty (30) frame per second rate. Over the years, resolution factors have increased from DVD resolutions (720×480 pixels) to HDTV (1920×1080 pixels). Currently, GPUs may even be required to handle decoding of a full bit stream at 1920×1080 for various codecs to support Blu-ray movie playback that may also have dual stream or PIP (picture in picture) capability.

In addition to meeting the processing demands created by higher resolutions, there is also a need for decoding at higher frame rates, such as ten-times greater than real time or more. For example higher frame rates can be used for transcoding from one format to another, smooth ultra-fast forward display, transmission order and display order conversions for smooth fast forward, smooth fast forward on 120 Hz and 240 Hz displays, video editing (especially where multiple video streams are merged into one final stream) and video search algorithms, such as for face or object detection.

GPUs have been developed with expanded processing functionality through configurations that utilize SIMD processing engines that include processing components known as shaders. For example, FIG. 2 illustrates a prior art GPU, namely the ATI Radeon HD 5800 series GPU. The Radeon HD 5800 series GPU has approximately 2.72 TeraFLOPS of processing power. That GPU features 20 SIMD engines, each with 16 processors (shaders), i.e. 320 shaders. The Radeon HD 5800 series GPU also sports 80 texture units, 4 per SIMD engine, and a Graphics Double Data Rate (GDDR) memory interface that offers approximately 150+GB/sec of peak bandwidth.

In the conventional DXVA interface, iDCT coefficients are typically sent using 32-bits per coefficient. The inventors have recognized that increasing the frame rate by, for example, factor of 10 or 100 times real time display speed or more can create a severe memory bandwidth bottleneck.

### SUMMARY OF EMBODIMENTS OF THE INVENTION

Methods and apparatus for utilizing coefficient compression in graphics decoding are provided. In one example, a computer processing unit (CPU) is interfaced with a graphic processing unit (GPU) for decoding video or other graphics where the CPU compresses extracted coefficients and passes compressed coefficient data to the GPU for decompression and processing. Preferably inverse transform (iT) coefficients are compressively encoded into uniformly sized data packets that are decodable on a per packet basis to facilitate massively parallel coefficient decoding.

An example CPU may include an encoder control component configured to adaptively select an encoding process for performing the iT compression based on the data content of the iT coefficients such that a selected iT coefficient encoding process is adaptively used for the iT coefficient encoding. In such case, the GPU is configured to receive data that identifies the selected iT coefficient encoding process along with the compressed iT coefficient data and has a decoder configured to decode the iT coefficient data using a coefficient decoding method complementary to the selected coefficient encoding process.

Component processors made in accordance with the invention can be connected to provide a distributed graphics decoding apparatus. Such an apparatus can, for example, include a first processing unit, such as a CPU, and a second processing unit, such as a GPU. The first processing unit is preferably configured to extract inverse transform (iT) coefficients that define image data and to encode the iT coefficients into compressed iT coefficient data. An interface is provided that is configured to pass the compressed iT coefficient data to the second processing unit. The second processing unit is preferably configured to decode the compressed iT coefficient data into iT coefficients that define the image data and to conduct iT processing of the iT coefficients.

Such a distributed graphic decoding apparatus can include a component configured to adaptively select an encoding process for performing the iT coefficient encoding based on the data content of the iT coefficients such that a selected encoding process is used for the coefficient encoding. Preferably, the first processing unit includes the component that adaptively selects the selected coefficient encoding process and is configured to include data that identifies the selected coefficient encoding process with the compressed iT coefficient data. Preferably, the coefficient encoding processes define uniformly sized data packets that are independently decodable in order to facilitate massively parallel coefficient decoding in the second processing unit.

In another example, a computer-readable storage medium is disclosed in which is stored a set of instructions for execution by one or more processors to facilitate manufacture of a selectively configured processing unit that includes a processing component configured to generate inverse discrete-cosine transform (iT) coefficients that define image data and an encoder configured to encode the iT coefficients into compressed iT coefficient data for output to another integrated circuit to complete iT processing.

In another example, a computer-readable storage medium is disclosed in which is stored a set of instructions for execution by one or more processors to facilitate manufacture of a selectively configured processing unit that includes an input configured to receive compressed inverse discrete-cosine transform (iDCT) coefficient data representing encoded iDCT coefficients that define image data, a decoder configured to decode the compressed iDCT coefficient data into iDCT coefficients that define the image data, and a processing component configured to iDCT process the iDCT coefficients.

The sets of instructions can be provided to facilitate manufacture of respective CPUs and GPUs. The computer-readable storage mediums can have instructions that written in hardware description language (HDL) instructions used for the manufacture of a device, such as an integrated circuit.

### BRIEF DESCRIPTION OF THE DRAWING(S)

FIG. 1 is a block diagram of an example of a conventional a distributed graphic decoding apparatus having a conventional computer processing unit (CPU) interfaced with a conventional graphic processing unit (GPU) where the CPU passes iDCT coefficients to the GPU for iDCT processing.

FIG. 2 is a block diagram of an example prior art GPU.

FIG. 3 is a block diagram of an example design of a distributed graphic decoding apparatus in accordance with an embodiment of the present invention.

FIG. 4 is an example of a data packet format for compressed iDCT coefficient data in accordance with an embodiment of the present invention.

FIGS. 5a and 5b are conventional MPEG-2 DCT coefficient block scan order encoding diagrams.

FIGS. 6a and 6b are examples of iDCT coefficient block scan order encoding diagrams in accordance in accordance with an embodiment of the present invention.

FIGS. 6c and 6d are further alternative examples of iDCT coefficient scan order encoding diagrams for the quadrants of the iDCT coefficient block scan order encoding diagrams illustrated in FIGS. 6a and 6b.

FIG. 7a is an example of non-zero iDCT coefficients within a series of iDCT coefficients.

FIG. 7b is an example of an alternative iDCT coefficient encoding of the series of iDCT coefficients containing the non-zero iDCT coefficients of FIG. 7a in accordance in accordance with an embodiment of the present invention.

FIG. 7c is an example of a data packet format for compressed iDCT coefficient data for the coefficient encoding of the example of FIG. 7b.

FIG. 8 is an example of iDCT coefficient sub-block scan order encoding diagrams in accordance in accordance with an embodiment of the present invention.

### DETAILED DESCRIPTION OF PREFERRED EMBODIMENTS

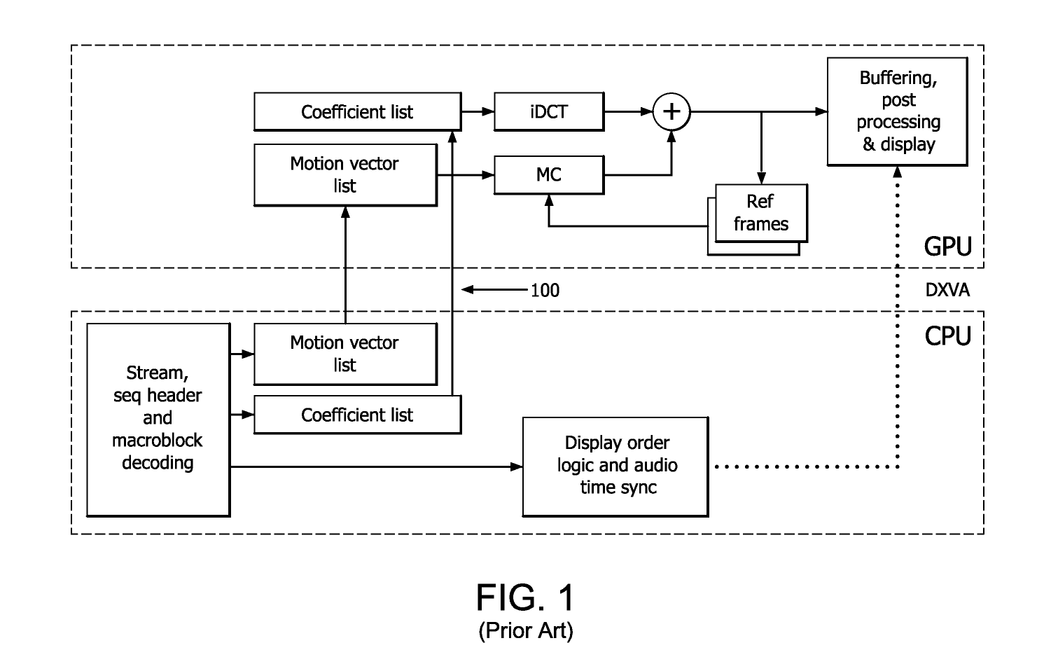

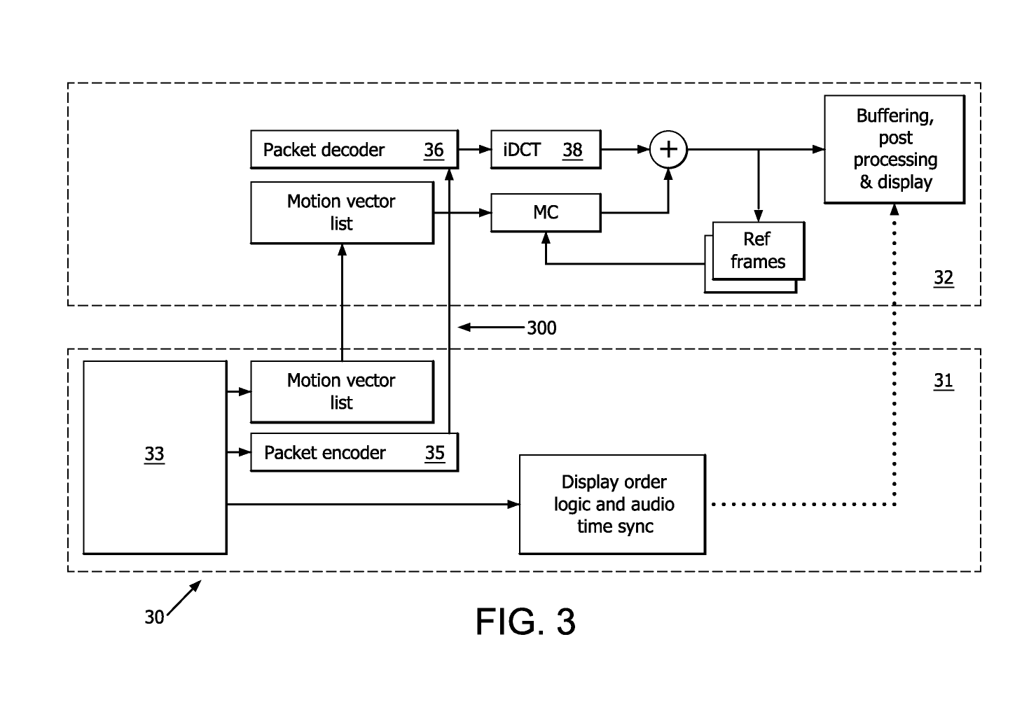

Referring to FIG. 3, an example of a distributed graphic decoding apparatus 30 is illustrated. The example apparatus 30 includes a first processing unit 31, such as a computer processing unit (CPU), and a second processing unit 32, such as a graphic processing unit (GPU) that includes an iDCT coefficient data interface 300, such as the iDCT coefficient data interface 100 illustrated in FIG. 1. As will be appreciated by those skilled in the art, the functionality of processing unit 31 and processing unit 32 may be physically within a single package or even on the same die (in addition to being connected via a conventional communications fabric). The first processing unit 31 includes a graphic/video bit stream decoding processing component 33 configured to extract inverse discrete-cosine transform (iDCT) coefficients that define image data and to perform other conventional functions such as generating motion vectors and data for display order logic and audio time synchronization. The extraction of the iDCT coefficients can be performed in a conventional manner, such as done by the prior art CPU of FIG. 1.

Unlike the prior art CPU illustrated in FIG. 1, the example first processing unit 31 includes an iDCT coefficient packet encoder 35 configured to compressively encode the iDCT coefficients generated by the processing component 33 into uniformly sized packets of compressed iDCT coefficient data. The encoder 35 outputs the compressed iDCT coefficient data over the interface 300 such as, for example, a conventional data bus on a computer motherboard. As will be appreciated by those skilled in the art, a computer motherboard may be present in various forms in a wide variety of computing devices including, but not limited to, servers, notebooks, mobile devices (e.g., smart phones), camcorders, tablets, etc.

Unlike the prior art GPU illustrated in FIG. 1, the example second processing unit 32 includes an iDCT coefficient packet decoder 36 having an input configured to receive the packets of compressed iDCT coefficient data generated by the packet encoder 35 of the first processing unit 31 via the interface 300. The decoder 36 decodes the packets of compressed iDCT coefficient data to reconstruct the iDCT coefficients that define the image data. The decoder then makes the decoded iDCT coefficients available to an iDCT processing component 38 that conducts iDCT processing of the iDCT coefficients. The iDCT processing performed by the iDCT processing component 38 can be performed in the same manner as the conventional iDCT processing performed by the GPU of FIG. 1.

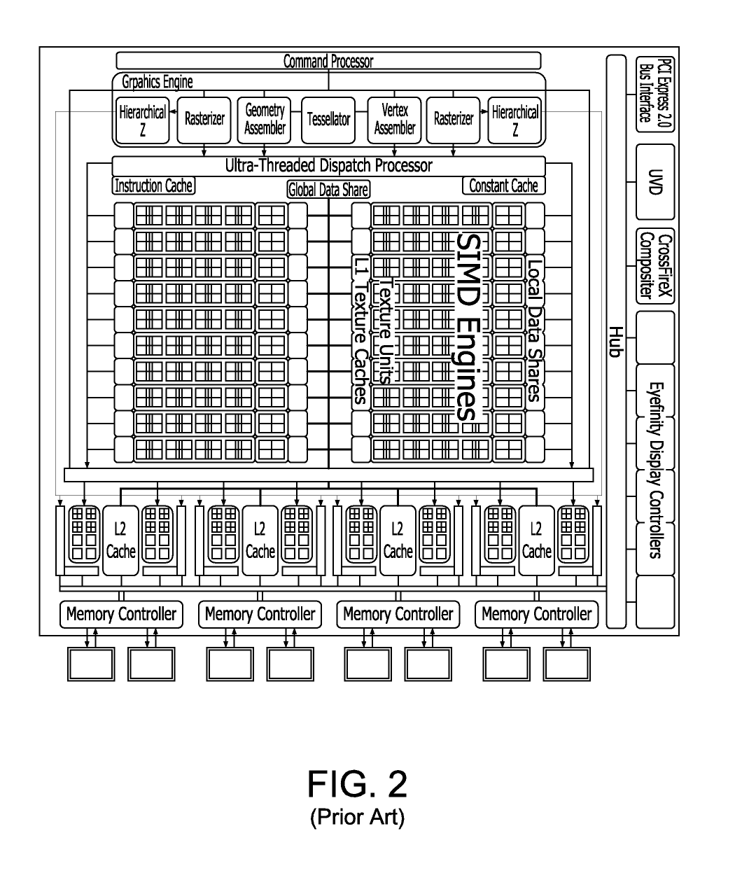

As discussed more fully below, the iDCT coefficient packet encoder 35 may be configured to compressively encode the iDCT coefficients utilizing various coefficient encoding methods. Preferably, the packets that are produced are individually decodable into identified iDCT coefficients to permit massively parallel coefficient decoding decompression by the second processing unit 32. For example, the second processing unit 32 may be a GPU similar to the GPU illustrated in FIG. 2. In such case, the decoder 36 is preferably configured to utilize the GPU shaders to conduct massively parallel coefficient decoding decompression of the received packets of compressed iDCT coefficient data to reconstruct the iDCT coefficients. By providing uniformly sized individually decodable packets, individual packets can be assigned to individual shader threads for parallel coefficient decoding.

In order fully utilize the GPU processing capability and the data transmission bus 300, the decoding apparatus 30 may include multiple processing units similar to first processing unit 31. For example, each such processing unit could be a processing core of a multi-core CPU. In such example, the multiple CPU cores may perform coefficient encoding for, for example, different portions of the same video stream or for different video streams and be configured to each send compressed coefficient data to the GPU 32 over the interface 300.

A component can be provided that is configured to adaptively select an encoding process for performing the coefficient encoding based on the data content of the iDCT coefficients such that a selected coefficient encoding process is used for the coefficient encoding. Preferably, the first processing unit 31 includes the component that adaptively selects the selected coefficient encoding process. For example, processing component 33 can be configured to perform this function. The processing component 33 can then provide data that identifies the selected coefficient encoding process to the encoder 35 which in turn can include the data that identifies the selected coefficient encoding process in packets with the compressed iDCT coefficient data that it encodes using the selected coefficient encoding process.

Image/video data is conventionally generated with respect to successive image/video frames. Compression method statistics can be gathered by the processing component 33 in connection with generating iDCT coefficients for each frame. The data compression preferably defines a series of data packets that encode the iDCT coefficients for an entire frame that is substantially shorter than the collective size of the iDCT coefficients for the frame.

Although it might be possible to use the gathered statistics for a frame to adaptively select a coefficient encoding method on a per packet basis for each frame, in order to limit the amount of time required for processing the data for that frame, preferably, such statistics are used to dynamically adapt and change the method of compression for iDCT coefficients of a subsequent frame. If desired, adaptive method changes can be deferred for multiple frames in order to prevent flip-flopping between methods and/or after similar statistics indicating a need for a different method are gathered for a selected series of frames

The coefficient encoding and coefficient decoding processes are preferably selected such that, for a given series of frames, the time Tenc needed for coefficient encoding iDCT coefficients by the encoder 35 for the series of frames, plus the interface time Tic needed for passing the compressed iDCT coefficient data from the first processing unit 31 to the second processing unit 32, plus the time Tdec needed for coefficient decoding and reconstructing the iDCT coefficients by the decoder 36 is less than or equal to the interface time Tiu needed for passing uncompressed iDCT coefficients from the first processing unit 31 to the second processing unit 32 over the interface 300.

Tenc+Tic+Tdec≦Tiu (Equation 1)

Generally, the adaptive method selection is configured to achieve an adequate time saving over the conventional method of merely communicating uncompressed iDCT coefficients, not the best, on each frame. Where the gathered statistics indicate that no processing time saving can be achieved or that the communication of uncompressed iDCT coefficients will take less time, the processing component 33 can be configured to direct the encoder 35 to forego coefficient encoding and simply pass the uncompressed iDCT coefficients to the second processing unit 32. In such case the decoder 36 will simply receive and store the uncompressed iDCT coefficients for processing by the iDCT processing component 38.

In the DXVA interface, macroblocks of uncompressed iDCT coefficients are typically sent using 32-bits per coefficient. Conventional interfaces may be designed to accommodate the communication of 32-bits per coefficient at a frame rate of 30 frames per second which is a typical rate for normal speed video display. However, if it becomes desirable to process video images at a significantly higher frame rate, such as 300 frames per second, the number of 32-bits per coefficients increases by a factor of 10 for a given time period and the interface may limit the overall speed attainable for graphics processing due to memory bandwidth bottleneck attributable to the interface. However, the present invention can significantly raise the limit of the overall processing speed for the same inter-processor interface.

The compressive encoding of the iDCT coefficients takes very little additional time over the time used to format uncompressed iDCT coefficients into 32-bits per coefficient data segments that are sent over the inter-processor interface. As noted above, shaders, such as found in conventional GPUs can be advantageously utilized to perform the coefficient decoding of processing to quickly reconstruct the iDCT coefficients by performing a highly efficient, massively parallel decompression.

In utilizing conventional GPU designs for the second processing unit 32, the time savings (or cost) of implementing the decoder 36 scales with the design; designs with few shader processors can achieve a baseline performance, designs with more shader processors can achieve higher performance.

In a first example of coefficient encoding performed by the encoder 35, the compressed stream consists of fixed sized packets that can vary in number on a per frame basis according to the frame's respective iDCT coefficients. Having a fixed size, such as 64 bytes, 128 bytes, etc. facilitates massively parallel decompression. As such, the decoder 36 can be configured to assign each received packet for iDCT coefficient reconstruction to any available shader within the second processing unit 32. Where the second processing unit 32 is configured similarly to the GPU illustrated in FIG. 2 that has 320 shaders that can concurrently process multiple threads in a time slice manner, up to 2560 packets may be able to be decoded concurrently where each shader is configured to concurrently process eight threads at one time.

Preferably, the second processing unit 32 is configured with multiple outputs that are configurable to drive one or more display devices. Current standard types of outputs include digital-to-analog converter (DAC) outputs used to drive many commercially available types of cathode ray tube (CRT) monitors/panels/projectors via an analog video graphics array (VGA) cable, digital visual interface (DVI) outputs used to provide very high visual quality on many commercially available digital display devices such as flat panel displays, and high-definition multimedia interface (HDMI) outputs used as a compact audio/video interface for uncompressed digital data for many high-definition televisions or the like. Alternatively or additionally, the second processing unit 32 can be included in a device that has a display and can be directly connected to drive the device's display. Once the second processing unit 32 reconstructs the iDCT coefficients, they are then processed in a conventional manner to provide a selectively formatted signal to drive a desired display device to display an image reflective of the decoded coefficients.

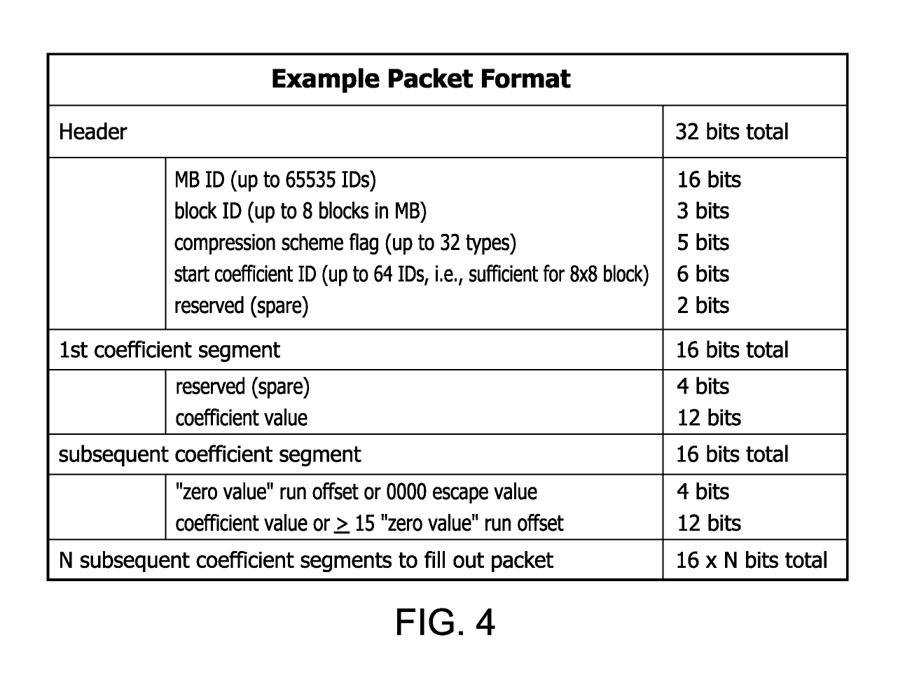

FIG. 4 illustrates an example packet format, starting with a header, followed by a first coefficient segment and then by a number of subsequent coefficient segments to fill out the data packet from which a variable number of iDCT coefficients can be decoded. If the data packet size is selected to be 64 eight-bit bytes, the header represents four bytes and there are 60 bytes for the compressed iDCT coefficient data. For the example of FIG. 4, each coefficient segment represents two bytes so there will be a first coefficient segment followed by 58 subsequent coefficient segments for a 64 eight-bit byte packet.

The fixed packet length, with a variable number of iDCT coefficients that can be decoded, generally, means that the data should be serially compressed, but allows for massively parallel coefficient decompression. As with encoding DCT coefficient, the iDCT coefficient encoding preferably takes advantage of the fact that many of the coefficients have a zero value.

The header of the FIG. 4 example format includes enough information to randomly start coefficient processing for any macroblock (MB), any block within a MB, at any iDCT coefficient within that block. Typically, there are sixty four iDCT coefficients in an 8×8 block that contain video data for an 8×8 block of pixels. Thus the example header format provides six bits that are used to identify the first non-zero iDCT coefficient within an identified block. Typically, there are six to eight blocks within a MB, numbered 0 to 3 for luma and 4 and 5 for chroma for 4:2:0 YUV color spaces and numbered 0 to 3 for luma and 4 to 7 for chroma for 4:2:2 YUV color spaces. Thus the example header format provides three bits that are used to identify a specific block within an identified MB for either YUV format. By providing sixteen bits in the example packet format for indentifying a MB, up to 65535 IDs can be provided which is more than sufficient to identify all the MBs for a 4000×4000 pixel display or even higher resolution displays.

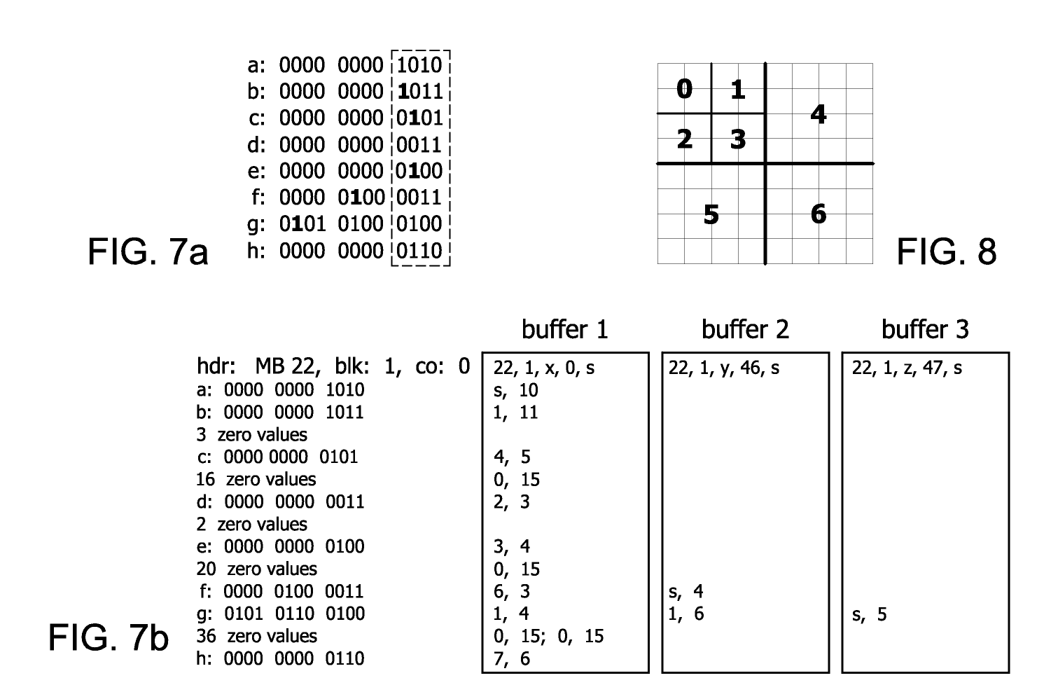

The example header of FIG. 4 also contains five bits to indicate which mode of compression was used to compress the iDCT coefficient data within the packet. There can be up to 32 types of compression selected for compression. The format for the coefficient segments of the data packet can be dependent upon the type of compression selected. FIG. 4 illustrates a first example where data for the entirety of typical twelve bit iDCT coefficients is encoded into the data packets. An alternative example is discussed below with respect to FIGS. 7a-c.

The header of the FIG. 4 example packet format concludes with two spare bits so that the header contains a bit size evenly divisible into a whole number of bytes.

The coefficient segments of the FIG. 4 example include four bits that represent a number of iDCT coefficients in a “run” of iDCT coefficients and twelve bits for twelve-bit iDCT coefficient values. In this context; a “run” is a series zero-value iDCT coefficients followed by a non-zero-value iDCT coefficient. For the first coefficient segment, the first four bits are spare since the first iDCT coefficient is the start coefficient identified by the header. For the subsequent coefficient segment, the first four bits identify the number of iDCT coefficients in a run that includes the next non-zero-value iDCT coefficient. Where there are 14 or less zero-value iDCT coefficients in a run, the last twelve bits for the segment contain the twelve-bit iDCT coefficient value for the non-zero-value iDCT coefficient in the run. Where there is are 15 or more zero-value iDCT coefficients in a run, an escape value, such as 0000 in the first four bits, is used to indicate that the last twelve bits for the segment identify the number of zero-value iDCT coefficients before the next non-zero-value iDCT coefficient.

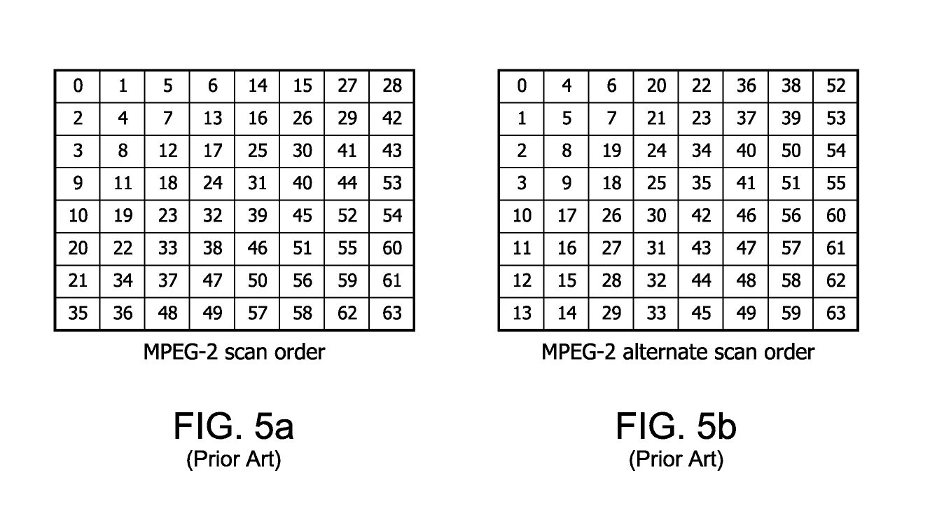

The order of numbering iDCT coefficients within an 8×8 block of coefficients for compressive coefficient encoding can be selected based on statistical analysis for providing more efficient compression. For MPEG-2 DCT coefficient encoding, there is a zigzag scan order that is illustrated in FIG. 5a that is used to improve the run-length encoding efficiency. There is also an alternative MPEG-2 DCT coefficient zigzag scan order that is preferred for inter-laced video illustrated in FIG. 5b. However, there are differences in encoding iDCT and DCT coefficients that make other encoding orders preferable.

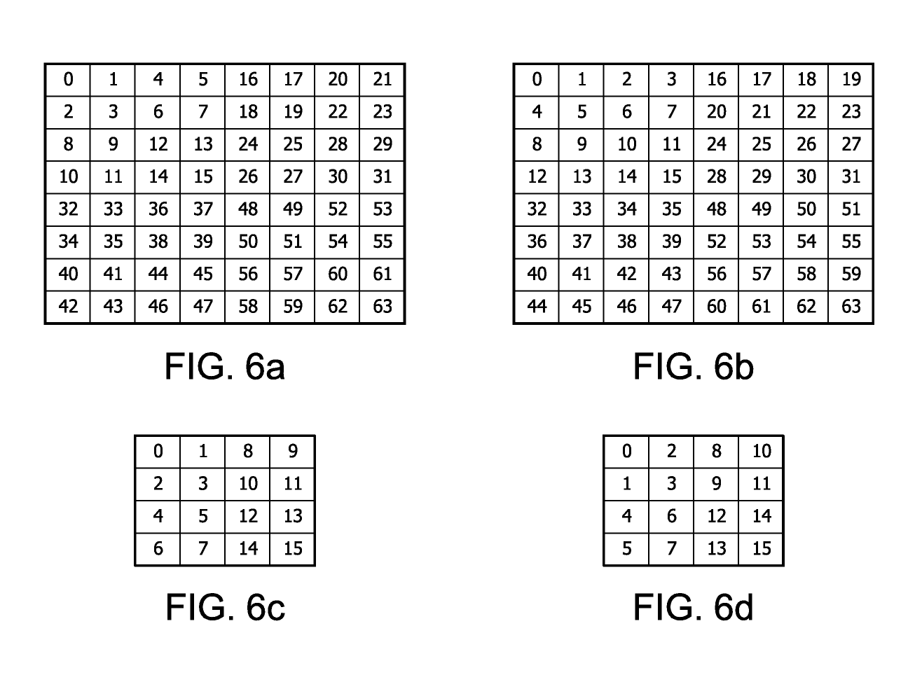

FIGS. 6a and 6b are examples of iDCT coefficient block scan order encoding diagrams in accordance in accordance with an embodiment of the present invention. In FIG. 6a, the scanning/encoding sequence is tiled over the 8×8 block into four 4×4 sub-blocks which are further divided into four 2×2 sections. The sequencing is left to right starting with a top row and proceeding to a bottom row with respect to coefficients within a 2×2 section, 2×2 sections within a 4×4 sub-block and 4×4 sub-blocks within a block. In FIG. 6, the scanning/encoding sequence is tiled over the 8×8 block into four 4×4 sub-blocks. The sequencing is left to right starting with a top row and proceeding to a bottom row with respect to coefficients within a 4×4 sub-block and 4×4 sub-blocks within a block. FIGS. 6c and 6d are further alternative examples of iDCT coefficient scan order encoding diagrams for the quadrants of the iDCT coefficient block scan order encoding diagrams illustrated in FIGS. 6a and 6b respectively.

The iDCT coefficient block scan order component of the coefficient encoding process can be selected based upon statistics gathered from blocks of a preceding frame of video taking into account whether the frame was encoded as progressive or interlaced. During the processing multiple methods could be attempted on a sample of the data to see which provided the best results. At the end of the frame the entire statistics can then be compiled to determine a better coefficient encoding alternate, for example by using some threshold. (i.e. adding hysteresis). If a better coefficient encoding process is indicated then a switch can be made to that alternative coefficient encoding process for the next frame.

Additionally, macroblocks (MBs) of a frame are typically processed in a conventional raster scan order in MPEG type encoding, left to right starting with a top row and proceeding to a bottom row. Similar MB decoding processing is preferred, but some amount of parallel compression may be obtained by partitioning the input MBs into groups, such as rows or slices, which may produce a slightly lower compression ratio due to some unused fragments of a contiguous memory buffer or the need for multiple independent memory buffers.

Another example of iDCT coefficient encoding is to partition the iDCT coefficient data into two or more streams, such that the base stream provides only a few of the least significant bits of each coefficient and the second and/or subsequent streams (columns) provide the remaining bits. Such an alternative, allows for a higher compression ratio since very few coefficients have a value that require 12 bits to represent.

A specific example is illustrated in FIGS. 7a-c, where the iDCT coefficient data is divided into three streams for coefficient encoding/decoding.

FIG. 7a is an example of eight non-zero iDCT coefficients with in a sequence of 85 iDCT coefficient that start in a block “1” of a MB “22.” In this sample data, of the eight non-zero 12-bit binary values, six can be encoded by using only four bits, one requires seven bits and one requires eleven. Such statistical facts can be used to devise a partitioning of the iDCT coefficient data into three streams for coefficient encoding, i.e. four least significant bits (LSB), four middle bits and four most significant bits (MSB) of each non-zero iDCT coefficient value.

FIG. 7c illustrates an example packet format for such coefficient encoding. As with the example header in FIG. 4, the FIG. 7c example header has sixteen bits to indentify a MB, three bits to identify a specific block within an identified MB, five bits to indicate which mode of compression was used to compress the iDCT coefficient data within the packet, six bits to identify the first non-zero iDCT coefficient within an identified block. Two spare bits so that the header contains a bit size evenly divisible into a whole number of bytes. For example, such a header would make up the first four bytes of a 64 eight-bit byte packet.

The coefficient segments of the FIG. 7a-c example include four bits that represent a number of iDCT coefficient portions in a “run” of iDCT coefficient data, but only four bits for one of the three partitions of the twelve-bit iDCT coefficient values. Thus each such segment would be one-byte of an example 64 eight-bit byte packet. In this context; a “run” is a series zero-value iDCT coefficient parts followed by a non-zero-value iDCT coefficient part of the respective partition.

As with the FIG. 4 example, for the first coefficient segment, the first four bits are spare since the first iDCT coefficient is the start coefficient identified by the header. For the subsequent coefficient segment, the first four bits identify the number of iDCT coefficient portions in a run that includes the next non-zero-value iDCT coefficient portion. Where there are 14 or less zero-value iDCT coefficient portions in a run, the last four bits for the segment contain the four-bit iDCT coefficient value portion for the non-zero-value iDCT coefficient portion in the run. Where there is are 15 or more zero-value iDCT coefficient portions in a run, an escape value, such as 0000 in the first four bits, is used to indicate that the last four bits for the segment identify the that there are at least 15 of zero-value iDCT coefficient portions before the next non-zero-value iDCT coefficient. Multiple coefficients segments, including the escape value are used to indicate multiple sets of 15 series of zero-values before a non-zero value in a run.

FIG. 7b illustrates the buffering of the iDCT coefficient data into an LSB stream in buffer 1, a middle bit stream in buffer 2 and a MSB stream in buffer 3 and illustrates the data for respective stream data packets derived from the set of 85 iDCT coefficients having the eight non-zero values of FIG. 7a. Each of the data packets would include additional data to fill out the byte size selected for the packets.

As illustrated in FIG. 7b, the packet for the LSB stream, contains a header indicating that the coefficient data within the packet starts with the iDCT coefficients of block 1 of MB 22. The coefficient encoding scheme “x” is indicated as the LSB stream of a three-way partitioning coefficient encoding of the iDCT coefficient data. “0” is used to indicate that the first non-zero value occurs in the respective first LSB coefficient portion of the series and “s” indicates the spare header bits. This represents four bytes of an example 64 byte packet.

In the first coefficient segment of the buffer 1 packet, “s” indicates the first four spare bits and the last four bits contain the value 10 that corresponds to the LSB portion of non-zero value “a.” For, the next coefficient segment of the buffer 1 packet, “1” in the first four bits indicates a run of one and the last four bits contain the value 11 that corresponds to the LSB portion of non-zero value “b.” For the next coefficient segment of the buffer 1 packet, “4” in the first four bits indicates a run of four and the last four bits contain the value 5 that corresponds to the LSB portion of non-zero value “c.” For the next coefficient segment of the buffer 1 packet, “0” in the first four bits indicates that the last four bits contains the first 15 zero-values in the run following non-zero value “c.” For the next coefficient segment of the buffer 1 packet, “2” in the first four bits indicates, in combination with the preceding segment, a run of seventeen and the last four bits contain the value 4 that corresponds to the LSB portion of non-zero value “d.” For the next coefficient segment of the buffer 1 packet, “3” in the first four bits indicates a run of three and the last four bits contain the value 4 that corresponds to the LSB portion of non-zero value “e.”

For the next coefficient segment of the buffer 1 packet, “0” in the first four bits indicates that the last four bits contains the first 15 zero-values in the run following non-zero value “e.” For the next coefficient segment of the buffer 1 packet, “6” in the first four bits indicates, in combination with the preceding segment, a run of 21 and the last four bits contain the value 4 that corresponds to the LSB portion of non-zero value “f.” For the next coefficient segment of the buffer 1 packet, “1” in the first four bits indicates a run of one and the last four bits contain the value 4 that corresponds to the LSB portion of non-zero value “g.”

For the next two coefficient segment of the buffer 1 packet, “0” in the first four bits indicates that the last four bits contains first and second sets of 15 zero-values in the run following non-zero value “g.” For the next coefficient segment of the buffer 1 packet, “7” in the first four bits indicates, in combination with the two preceding segments, a run of 37 and the last four bits contain the value 6 that corresponds to the LSB portion of non-zero value “h.”

The above represents the coefficient encoding of the first sixteen bytes for a 64 eight-bit byte packet. The remainder of the packet would be filled with further LSB portions of iDCT coefficient data.

As further illustrated in FIG. 7b, the packet for the middle bit stream, contains a header indicating that the coefficient data within the packet starts with the iDCT coefficients of block 1 of MB 22. The coefficient encoding scheme “y” is indicated as the middle bit stream of the three-way partitioning coefficient encoding of the iDCT coefficient data. “46” is used to indicate that the first non-zero value occurs in the respective forty-seventh middle coefficient portion of the series and “s” indicates the spare header bits. This represents four bytes of an example 64 byte packet.

In the first coefficient segment of the buffer 2 packet, “s” indicates the first four spare bits and the last four bits contain the value 4 that corresponds to the middle bit portion of non-zero value “f.” For, the next coefficient segment of the buffer 2 packet, “1” in the first four bits indicates a run of one and the last four bits contain the value 6 that corresponds to the middle bit portion of non-zero value “g.”

The above represents the coefficient encoding of the first six bytes for a 64 eight-bit byte packet. The remainder of the packet would be filled with further middle bit portions of iDCT coefficient data.

As further illustrated in FIG. 7b, the packet for the MSB stream, contains a header indicating that the coefficient data within the packet starts with the iDCT coefficients of block 1 of MB 22. The coefficient encoding scheme “z” is indicated as the MSB stream of the three-way partitioning coefficient encoding of the iDCT coefficient data. “47” is used to indicate that the first non-zero value occurs in the respective forty-eighth MSB portion of the series and “s” indicates the spare header bits. In the first coefficient segment of the buffer 2 packet, “s” indicates the first four spare bits and the last four bits contain the value 4 that corresponds to the middle bit portion of non-zero value “g.” The above represents the coefficient encoding of the first five bytes for a 64 eight-bit byte packet. The remainder of the packet would be filled with further middle bit portions of iDCT coefficient data.

As illustrated in FIG. 7b, for a given series/frame of iDCT coefficient data, the number of packets needed to encoded the middle and MSB streams of data in a three-way partitioning of iDCT coefficient data is relatively small in comparison with the number of packets needed to encoded the LSB stream. In the second processing unit 32, the packet decoder 34 can accordingly be configured to first decompress the base LSB stream, which has the majority of the data. The smaller amounts of middle bit and MSB data can then be decompressed and added to an iDCT coefficient memory in subsequent coefficient decoding passes which would tend to be very short.

If the bit-stream bit-rate increases or decreases by substantial amounts due to a change in quantization, the number of bits used for the bit partitioning can be altered or the compression can fallback to a single stream if no improvement was calculated for using a multi-stream partitioning.

Based on statistical data for different resolutions and bit-rates of the encoded data stream, different combinations of the number of bits used to indicate run length and non-zero coefficient data can be used to provide enhanced data compression.

For example, for a two-way partition, 12-bit iDCT coefficient data can be divided into a 2-bit LSB stream and a 10-bit MSB stream. In such case, using the same type of data packet header of FIGS. 4 and 7b, the coefficient segments for the LSB stream can include six bits that represent a number of iDCT coefficient portions in a “run” of iDCT coefficient data and only two bits for the LSB portion of the iDCT coefficient data to define one-byte segments. The coefficient segments for the MSB stream can include six bits that represent a number of iDCT coefficient portions in a “run” of iDCT coefficient data and ten bits for the MSB portion of the iDCT coefficient data to define two-byte segments.

For a further example of a three-way partition, 12-bit iDCT coefficient data can be divided into a 2-bit LSB stream, a 2-bit middle stream and an 8-bit MSB stream. In such case, using the same type of data packet header of FIGS. 4 and 7b, the coefficient segments for the LSB stream can include six bits that represent a number of iDCT coefficient portions in a “run” of iDCT coefficient data and two bits for the LSB portion of the iDCT coefficient data to define one-byte segments. The coefficient segments for the middle-bit stream can also include six bits that represent a number of iDCT coefficient portions in a “run” of iDCT coefficient data and two bits for the portion of the iDCT coefficient data to define one-byte segments. The coefficient segments for the MSB stream can include eight bits that represent a number of in a “run” of iDCT coefficient data and eight bits for the MSB portion of the iDCT coefficient data to define two-byte segments. Preferably the type of partitioning used is indicated by the header bits

Where more than one buffer is to be processed in serial passes in the packet decoder for decompression, each buffer after the first can contain one value indicating how many bits have preceded it.

As will be recognized to those skilled in the art, there are a wide variety of compression partitioning schemes that can be used. In the case where there are a small number of bits required for both the coefficients and the runs additional schemes can be used, such as 2r-2c-2r-2c (2-bit run, 2-bit coefficient, 2-bit run, 2-bit coefficient) or 2r-2c-2c-2c (2-bit run, 2-bit coefficient, 2-bit coefficient, 2-bit coefficient) or 4r-2c-2c (4-bit run, 2-bit coefficient, 2-bit coefficient), 6r-2c-2c-2c-2c (6-bit run, 2-bit coefficient, 2-bit coefficient, 2-bit coefficient, 2-bit coefficient) etc. The schemes with a set of run bits followed by multiple sets of coefficient bits are preferably used when there is a high density of non-zeroes, although in some cases one or more of the sets of coefficient bits made define a zero coefficient.

The number of bits to define a coefficient segment (run value bits plus coefficient value bits) do not have to add up to be multiples of 8, but it can enhance the performance on the first and/or second processing units 31, 32 to have an even byte count.

All packets should contain legal values for the entire fixed length to prevent the need for performing special processing for non-conforming packets. Padding to the end of a packet with all zeroes can be used to accomplish this. This can potentially get interpreted as a number of zero coefficient values or as one or more escape codes (for runs that exceed the bits being used). Any escape in effect at the end of a packet can get cancelled in the decoder. Padding with zeroes can be used for a final packet of a buffer partitioning or any number of times to allow for parallel processing on the encoding side for end of rows or slices, for example, where such groups of MBs are processed in parallel.

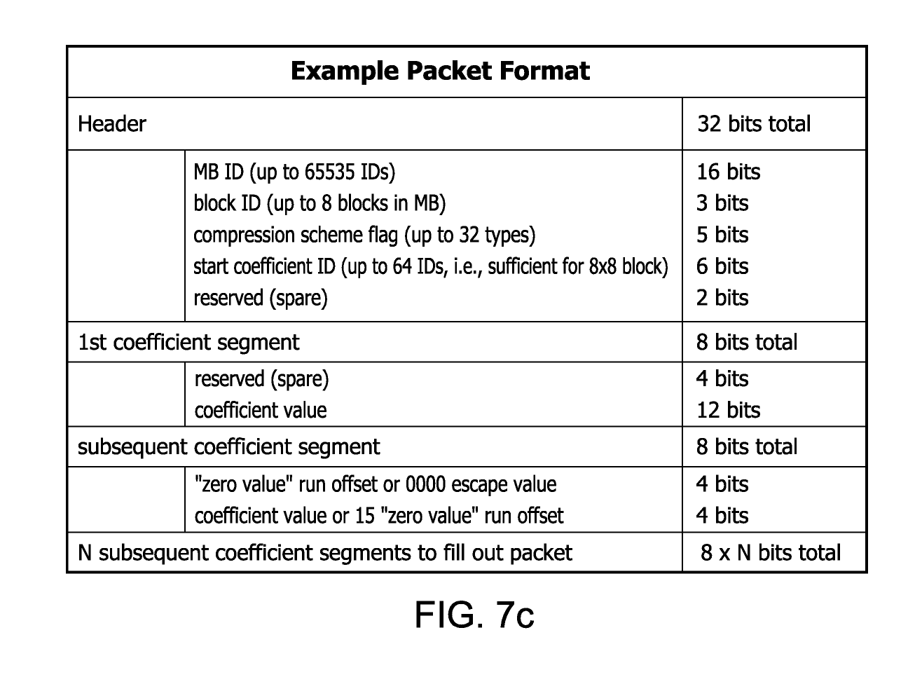

In the case where the number of coefficients is sparse and the number of bits needed to encode the “runs” is large, a further alternate compression may be advantageously used based on a bitmask grouping. In such an alternate scheme, instead of indicating zero values in terms of runs, zero-values for entire portions of an iDCT coefficient block the header is a bitmask that contains a zero for no coefficient and a 1 for a non-zero coefficient. FIG. 8 illustrates one bit mask identification of different sized tile portions of iDCT coefficients encoded in the sequence indicated in FIG. 6a. A bit mask value can be used to identify whether or not there are any non-zero iDCT coefficients in any of the tile segments numbered 0 through 6. Where the bit mask indicates there are non-zero iDCT coefficients, data with respect to those coefficients then follow the bit mask value. The data can be in the form of all of the iDCT coefficients in the respective bit mask tile area or can be in the form of run values and coefficient values as describe above. Variations using 8, 16, 32 or 64 bits for the bitmask, can be used where the statistics show a compression gain.

In the case where a bit mask value for an iDCT coefficient block and its related coefficient data overflows past the end of a packet boundary, the bits in the mask for the coefficients beyond the packet boundary can be set to zero and the same block bitmask can be repeated in the next packet with the previously compressed coefficients mask set to zero and the bits for the remaining coefficients are set to one as may be required.

Although features and elements are described in the examples above are in the context of compression for processing of iDCT coefficients and are tailored to the statistical nature of such coefficients, the examples are not intended to be limiting. The methods and apparatus can readily be adapted for any buffering/compression of sparse data (i.e. relatively few non-zero data elements interspersed with many zero data elements) with generally few significant bits of information per non-zero element.

Also, iDCT coefficients are generally used for the specific transforms contained in MPEG and JPEG codecs. Other codecs utilize transforms that are similar to iDCT, but are different. Generally, some type of inverse transform (iT) of coefficients is used with respect to decoding of video/graphics data which may or may not be iDCT. There can also be relatively equivalent data that is not technically characterized as iT coefficients to which the disclosed methods and apparatus are applicable.

By utilizing the invention, devices, such as tables, smart phones, DTVs, etc., for example, can be produced with reduced component costs, reduced design efforts which could otherwise require complex and costly memory and memory interfaces.

Although features and elements are described above in particular combinations, each feature or element can be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method of utilizing coefficient compression for facilitating graphics decoding comprising:
encoding in a first processing unit coefficients that are used to represent an image into compressed coefficient data;
passing the compressed coefficient data to a second processing unit; and
decoding in the second processing unit the compressed coefficient data into the coefficients that represent the image.

2. The method of claim 1 wherein the coefficients are inverse transform (iT) coefficients further comprising:
extracting the iT coefficients in the first processing unit;
adaptively selecting a coefficient encoding process for performing the encoding based on the data content of the iT coefficients where the coefficient encoding process is selected from among a set of coefficient encoding processes that encode the iT coefficients into uniformly sized data packets; and
processing the decoded coefficients in the second processing unit.

3. The method of claim 2 wherein the first processing unit selects the coefficient encoding process and passes data packets to the second processing unit where each data packet contains data that identifies the selected coefficient encoding process used to encode the compressed iT coefficient data within the packet.

4. The method of claim 2 wherein the second processing unit processes the decoded coefficients to provide a selectively formatted signal to drive a desired display device to display an image reflective of the image.

5. A distributed graphic decoding apparatus comprising:
a first processing unit configured to extract coefficients that define image data;
the first processing unit configured to encode the coefficients into compressed coefficient data and to pass the encoded coefficients to a second processing unit; and
the second processing unit configured to decode the compressed coefficient data into coefficients that define the image data.

6. The apparatus of claim 5 wherein the first processing unit is configured to extract inverse transform (iT) coefficients and the second processing unit is configured to process of the decoded coefficients to provide a selectively formatted output to drive a desired type of display device, the apparatus further comprising a component configured to adaptively select a coefficient encoding process for performing the encoding based on the data content of the iT coefficients where the coefficient encoding process is selected from among a set of coefficient encoding processes that encode the iT coefficients into uniformly sized data packets.

7. The apparatus of claim 6 wherein the first processing unit includes the component that adaptively selects the selected coefficient encoding process and the first processing unit is configured to encode the iT coefficients into data packets where each data packet contains data that identifies the selected coefficient encoding process used to encode the compressed iT coefficient data within the packet.

8. A method of utilizing coefficient compression for facilitating graphics decoding comprising:
extracting in a first processing unit coefficients that define image data; and
encoding in the first processing unit the coefficients into compressed coefficient data.

9. The method of claim 8 wherein the extracted coefficients are inverse transform (iT) coefficients further comprising:
adaptively selecting a coefficient encoding process for performing the coefficient encoding based on the data content of the iT coefficients where the coefficient encoding process is selected from among a set of coefficient encoding processes that encode the iT coefficients into uniformly sized data packets; and
outputting the data packets for completing coefficient processing in another processing unit.

10. The method of claim 9 wherein the first processing unit selects the selected coefficient encoding process and outputs data packets where each data packet contains data that identifies the selected encoding process used to encode the compressed iT coefficient data within the packet.

11. An integrated circuit for facilitating distributed graphic decoding comprising:
a processing component configured to extract coefficients that define image data; and
an encoder configured to encode the coefficients into compressed coefficient data for output another integrated circuit to complete coefficient processing.

12. The integrated circuit of claim 11 wherein the extracted coefficients are inverse transform (iT) coefficients further comprising an encoder control component configured to adaptively select a coefficient encoding process for performing the encoding based on the data content of the iT coefficients such that a coefficient selected encoding process is used for the coefficient encoding where the coefficient encoding process is selected from among a set of coefficient encoding processes that encode the iT coefficients into uniformly sized data packets.

13. The integrated circuit of claim 12 wherein the encoder is configured to output data packets where each data packet contains data that identifies the selected coefficient encoding process used to encode the compressed iT coefficient data within the packet.

14. A computer-readable storage medium storing a set of instructions for execution by one or more processors to facilitate manufacture of an integrated circuit for facilitating distributed graphic decoding that includes:
a processing component configured to extract coefficients that define image data; and
an encoder configured to encode the coefficients into compressed coefficient data for output another integrated circuit to complete coefficient processing.

15. The computer-readable storage medium of claim 14 wherein the instructions are hardware description language (HDL) instructions used for the manufacture of a device.

16. A method of utilizing coefficient compression for facilitating decoding comprising:
receiving compressed inverse transform (iT) coefficient data by a processing unit representing encoded iT coefficients that define image data;
decoding in the processing unit the compressed iT coefficient data into iT coefficients that define the image data.

17. The method of claim 16 wherein the processing unit receives compressed iT coefficient data in uniformly sized data packets that include data that identifies a selected coefficient encoding process used to compressed iT coefficient data contained in the respective data packet and the processing unit decodes the compressed iT coefficient data within each data packet using a coefficient decoding method complementary to the selected coefficient encoding process identified within the packet.

18. The method of claim 16 wherein the GPU receives the compressed iT coefficient data in uniformly sized, independently decodable data packets and decodes the compressed iT coefficient data using massively parallel coefficient decoding of the received data packets.

19. The method of claim 16 further comprising processing the decoded iT coefficients to provide a selectively formatted signal to drive a desired display device to display an image reflective of the image data.

20. An integrated circuit for facilitating distributed graphic decoding comprising:
an input configured to receive compressed inverse transform (iT) coefficient data representing encoded iT coefficients that define image data;
a decoder configured to decode the compressed iT coefficient data into iT coefficients that define the image data; and
a processing component configured to iT process the decoded iT coefficients.

21. The integrated circuit of claim 20 wherein the input is configured to receive the compressed iT coefficient data in uniformly sized data packets that include data that identifies a selected coefficient encoding process used to compressed iT coefficient data contained in the respective data packet and the decoder is configured to decode the compressed iT coefficient data within each data packet using a coefficient decoding method complementary to the selected coefficient encoding process identified within the packet.

22. The integrated circuit of claim 20 wherein the input is configured to receive the compressed iT coefficient data in uniformly sized, independently decodable data packets and the decoder is configured to decode the compressed iT coefficient data using massively parallel coefficient decoding of received data packets.

23. A computer-readable storage medium storing a set of instructions for execution by one or more processors to facilitate manufacture of an integrated circuit that includes:
an input configured to receive compressed inverse transform (iT) coefficient data representing encoded iT coefficients that define image data;
a decoder configured to decode the compressed iT coefficient data into iT coefficients that define the image data; and
a processing component configured to iT process the iT coefficients.

24. The computer-readable storage medium of claim 23 wherein the instructions are hardware description language (HDL) instructions used for the manufacture of a device.
